(19) United States
(12) Patent Application Publication
(10) Pub. No.: US 2002/0092931 A1
(43) Pub. Date: Jul. 18, 2002

(54) Design of the nozzle arrangement on the spray tube of the conventional, oscillating lawn or hose sprinkler

(76) Inventor: Alex Marcos Coote, Mississaaga (CA)

Correspondence Address: ALEX H. COOTE, 1612 Broadmoor Ave., Mississaaga, ON, L5G3V2, CA

(21) Appl. No.: 10/086,519

(22) Filed: Mar. 4, 2002

(30) Foreign Application Priority Data
Mar. 22, 1999 (CA) 2,226,247

(51) Int. Cl. B05B 1/20

(52) U.S. Cl. 239/556; 239/566; 239/567

(57) ABSTRACT

This invention provides an improved water distribution at the end of the stroke of an oscillating lawn sprinkler to overcome the undesirable “puddling” affect. This is obtained through the use of more than one sized nozzle, each producing a distinctive water spray trajectory, to provide a more uniform distribution of water. The nozzles may be positioned in 1 row as in the conventional oscillating sprinkler, in two or more rows parallel to the longitudinal axis, or one row of nozzles set at an inclination to the vertical, sideways, left and right at the mid-stroke position.

### BACKGROUND OF THE INVENTION

This invention pertains to the design of oscillating lawn sprinklers, category D23/216. It is designed to correct the non-uniform distribution of water resulting in the well known puddling effect at the end of each to and fro stroke of the sprinkler by providing an improved water spray pattern.

In the past, many attempts have been made to overcome this “puddling” effect. They have all been focused on mechanical designs to overcome the “top dead center” phenomenon, the pause at the end of the stroke, in the translation of rotary to reciprocating motion. These have given rise to numerous inventions, based on mechanical arrangements but my invention is the first, to my knowledge, to overcome the problem by changing the focus of attack from a purely mechanical one, to one of arrangement of the nozzles and hence the water spray pattern.

### BRIEF SUMMARY OF THE INVENTION

In the conventional, typical oscillating, lawn or hose sprinkler, it is known to have a spray tube, having one row of uniform holes or nozzles, which oscillates back and forth in a “to and fro” motion. Water emitted through these holes or nozzles, form a spray of jets of uniform trajectory which form a single line where the jets fall on the ground. At the end of the stroke, where the “to and fro” motion is halted temporarily, this gives rise to an undesirable concentration of water, known as “puddling”.

In this invention the positioning of the nozzles on the spray tube in a unique arrangement is used. This consists of using one row of nozzles of more than one size or type.

OR

More than one row of nozzles with one or more nozzle sizes or types.

OR One row of nozzles, of one or more sizes or types, at an inclination to the vertical, left and right, with the spray tube in mid-stroke position.

With the use of this arrangement, varying trajectories of the water sprays are obtained, so the point of contact, where the jets hit the ground at the end of each stroke, is not in a single line, but is spread over a greater area. This distribution of the water, sprayed over a larger area, overcomes the unwanted so-called “puddling” effect.

### BRIEF DESCRIPTION OF THE SEVERAL VIEWS OF THE DRAWING

In drawings which illustrate embodiments of the invention, case (a) shows the use of more than one sized nozzle in one row.

FIG. 1 is a plan view showing various sized nozzles on the spray tube and their respective water jet sprays or trajectories, which provide improved distribution of water over a wider area.

FIG. 2 is an end elevation showing the dotted position of the spray tube at the end of the stroke and the corresponsing water jet trajectories. The water pattern is shown at the end of one stroke only for clarity in the drawings, in FIGS. 1 and 2.

FIG. 3 shows a side view of the sprinkler incorporating more than one nozzle size in the spray tube.

Case (b) illustrates the use of more than one row of nozzles.

FIG. 4 is a plan view showing a spray tube with two rows of nozzles, which from their position on the spray tube, project their water jets over a wider area.

FIG. 5 is an end elevation showing the dotted position of the spray tube at the end of the stroke with the corresponding trajectories. The water spray pattern is shown at the end of one stroke only for clarity in the drawings in FIGS. 4 and 5.

FIG. 6 shows a side view of the sprinkler incorporating more than one row of nozzles.

Case (c) illustrates the use, in a single row, of a type of nozzle having its spray at an inclination from the vertical, left and right, with the spray-tube in mid-position.

FIG. 7 is a plan view showing the nozzles in a single row with their water jet sprays at an inclination from the vertical and the resulting water distribution pattern.

FIG. 8, is the end elevation showing the inclination from the vertical of the nozzles in a single row at mid-position. The end of stroke position is shown dotted with the improved water distribution shown for one end of the stroke position only for illustration purposes.

FIG. 9 shows a side view of the sprinkler incorporating the nozzles in a single row.

### DETAILED DESCRIPTION OF THE INVENTION

This invention consists of an improvement to the existing conventional oscillating lawn sprinkler spray tube by using an unique nozzle arrangement design.

The design feature is to provide:

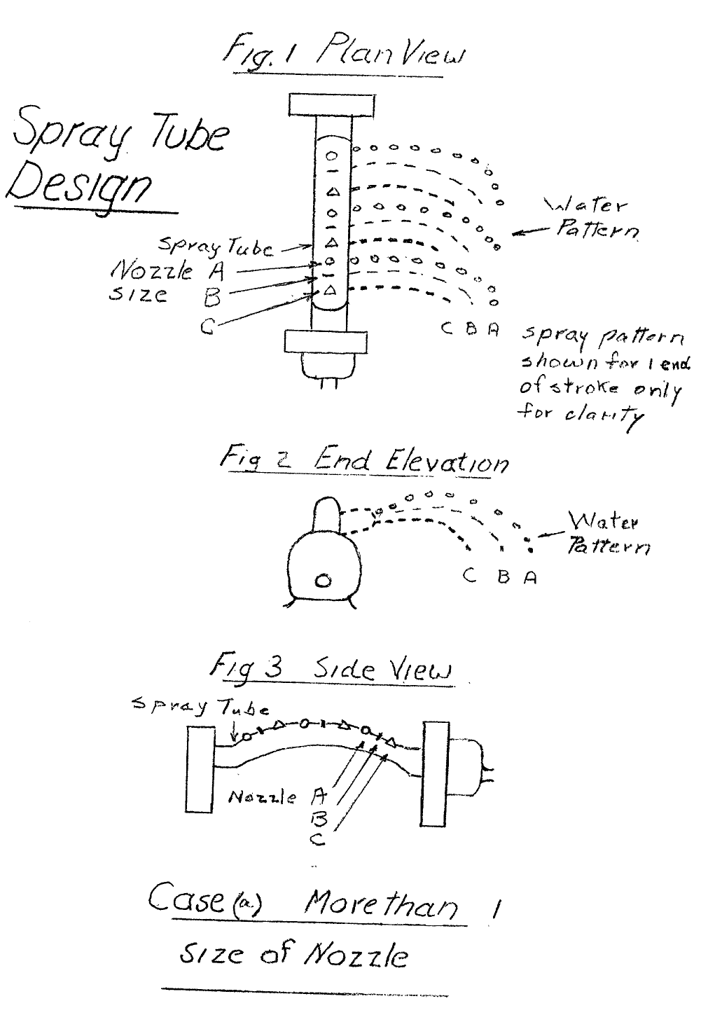

(a) More than one nozzle size in any one sprinkler spray tube in place of the conventional arrangement where they all are of uniform size, and in one row, as shown in FIGS. 1, 2, and 3.

OR

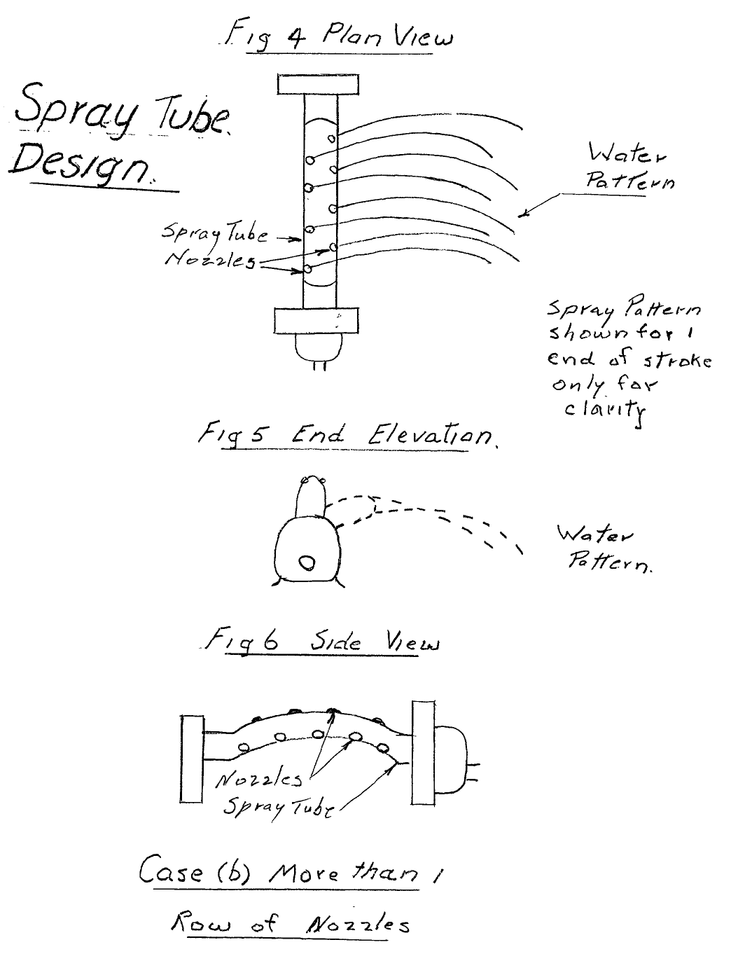

(b) More than one row of nozzles of one or more nozzle sizes as per FIG. 4, 5, and 6.

OR

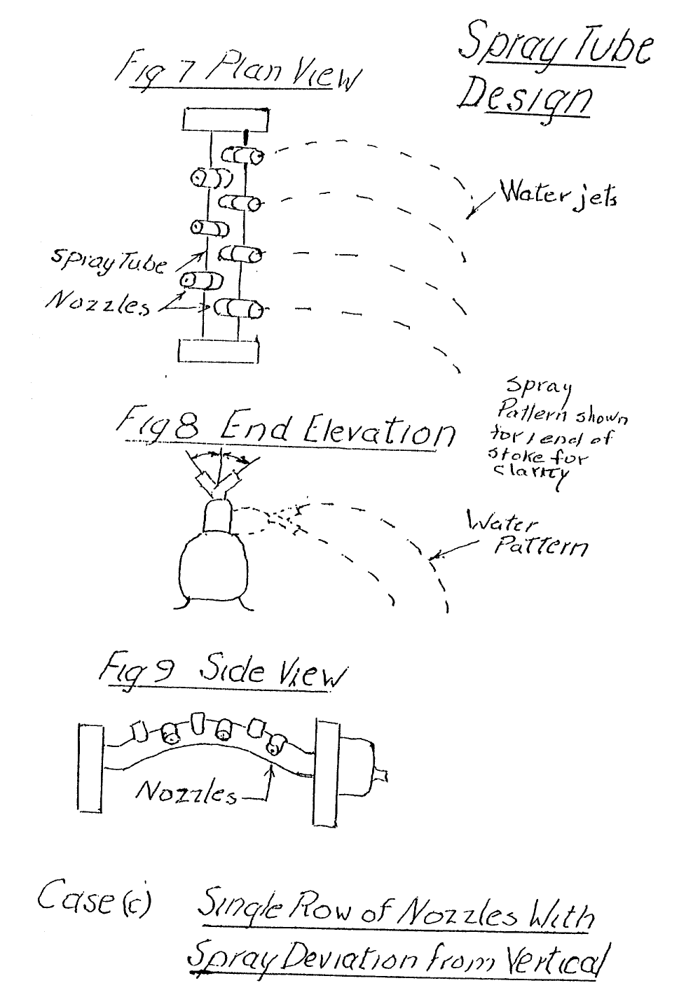

(c) One row of nozzles, of one or more sizes, at an inclination to the vertical, sideways, left and right, with the spray tube in mid-stroke position as per FIGS. 7, 8, and 9.

Case (a)

In case (a) each size of nozzle produces its distinctive trajectory, or length of jet of water. The number of nozzle sizes and the pattern or arrangement in the row on any spray tube, may be varied according to any particular application.

This patent design application covers any use of more than one nozzle size in any sprinkler spray tube, to provide a more uniform distribution of water over the sprinkled area toward the end of each stroke. This is shown in FIGS. 1, 2, 3, where for example, three nozzle sizes are used in one pattern for illustration purposes. This shows, at the end of each stroke—to and fro—the water being placed over three locations A, B, and C, according to the type of nozzle used, A, B, or C, instead of all at location A, as in the present conventional sprinkler using only one size of nozzle.

This reduces the amount of water at A by two thirds (⅔) and distributes it at locations B and C. This reduces the well known puddling effect at A and increases the water distribution over areas at C and B in a more uniform manner. The water distribution in mid-stroke remains the same as the present sprinkler design.

Case (b)

In case (b) more than one row of nozzles is used and the improved distribution of water is achieved by the use of more than one row of nozzles and their location on the circumference of the spray tube. The location and number of rows of nozzles may be varied as required. In FIGS. 4, 5, and 6, two rows of nozzles are shown, for illustration only, to show the desired improved water distribution.

This design may also incorporate more than one nozzle size for added improvement. The improvement in the water distribution is achieved by distributing the water through two dispersal areas (one for each row of nozzles) as against all being delivered to one line of contact at each end of the stroke in the conventional arrangement.

Case (c)

In Case (c) one row of nozzles, set an an inclination to the vertical, sideways, left and right, at mid-stroke position to provide distinct trajectories is used. Where more than one size of nozzles is incorporated, additional trajectories are obtained thus providing a better improvement in the water distribution in a manner similar to Case (a).

What I claim as my invention is:

01. A spray tube having a distinct pattern arrangement of nozzles or orifices, to produce a variety of water jet trajectories, for an improved distribution of water.

02. The distinct pattern arrangement of nozzles or orifices, as defined in claim No. 1 consisting of two or more types or sizes of nozzles or orifices, each producing a different trajectory of water jet, all placed in line on the top of the spray tube in line with its longitudinal axis and producing vertical water jets at mid-stroke.

03. The distinct pattern arrangement of nozzles or orifices as defined in claim No. 1. consisting of one or more types or sizes of nozzles or orifices, in two or more rows, parallel to the longitudinal axis.

04. The distinct pattern arrangement of nozzles or orifices as defined in claim No. 1 consisting of one row of one or more size of nozzles at an inclination to the vertical at mid-stroke, sideways, left and right to produce more than one trajectory
